(19) United States
(12) Patent Application Publication
(10) Pub. No.: US 2008/0132168 A1
(43) Pub. Date: Jun. 5, 2008

(54) Portable communication device with detachable wireless headset

(76) Inventors: Gil Segev, Tel Aviv (IL); Ziv Nevo, Shoresh (IL); Tal Goori, Gederam (IL); Anna Feldman, Be'er Sheva (IL)

Correspondence Address: INTEL CORPORATION;c/o INTELLEVATE, LLC, P.O. BOX 52050, MINNEAPOLIS, MN, 55402, US

(21) Appl. No.: 11/607,555

(22) Filed: Nov. 30, 2006

(51) Int. Cl. H04B 7/00; H04M 1/00

(52) U.S. Cl. 455/41.2; 455/575.2

(57) ABSTRACT

A portable communication device such a mobile phone is disclosed which may be configured to communicate using a wireless personal area network (WPAN) protocol and one or more wireless local area network (WLAN), wireless metropolitan area network (WMAN) or wireless wide area network (WWAN) protocols. The portable communication device includes a port to store and/or charge a separate WPAN device such as a wireless headset and in certain embodiments, the port may charge a battery of wireless headset so that both the portable communication device and wireless headset may be carried as an integrated single unit and/or charged using a single charging cord. Additional embodiments and variations are also disclosed.

### BACKGROUND OF THE INVENTION

Wireless communication devices such as cell phones have become very popular in recent years. At the time of this disclosure it is estimated that there are over 2.2 billion mobile subscriber connections worldwide. As the popularity of these devices has increased, a smaller form factor and increased media capabilities for mobile handsets has been the subject of unending pursuit.

Additionally, the development of short range wireless technologies such as BLUETOOTH™ or other protocols for wireless personal area networks (WPANs) have lead to the development of wireless headsets that can be used with fixed and portable communication devices.

Currently, short range wireless headsets and longer range communication devices, although useable together, are independent and unrelated devices. This requires a user of both types of devices to carry each device separately and charge each device on its own terms using dedicated charging devices. Accordingly, it would be desirable to integrate a short range wireless device with a long range communication device to facilitate increased portability and/or reduce charging requirements of two independent and unrelated systems.

### BRIEF DESCRIPTION OF THE DRAWING

Aspects, features and advantages of embodiments of the present invention will become apparent from the following description of the invention in reference to the appended drawing in which like numerals denote like elements and in which:

FIG. 1 is diagram of an example wireless device including both a short range wireless device and a long range wireless device according to various embodiments; and

FIG. 2 is a block diagram of a power supply arrangement for integrating long range and short range wireless communication devices according to one embodiment.

### DETAILED DESCRIPTION OF THE INVENTION

While the following detailed description may describe example embodiments of the present invention in relation to wireless personal area networks (WPANs), the invention is not limited thereto and can be adapted using other types of wireless networks where similar advantages may be obtained. Such networks specifically include, if applicable, broadband wireless metropolitan area networks (WMANs), wireless local area networks (WLANs) and/or wireless wide area networks (WWANs) such a cellular networks and the like.

The following inventive embodiments may be used in a variety of applications including transceivers or receivers of a radio system. Radio systems specifically included within the scope of the present invention include, but are not limited to, cellular radiotelephone systems, satellite systems, personal communication systems (PCS), two-way radio systems and two-way pagers as well as computing devices including such radio systems such as personal computers (PCs) and related peripherals, personal digital assistants (PDAs), personal computing accessories, hand-held communication devices and all existing and future arising systems which may be related in nature and to which the principles of the inventive embodiments could be suitably applied.

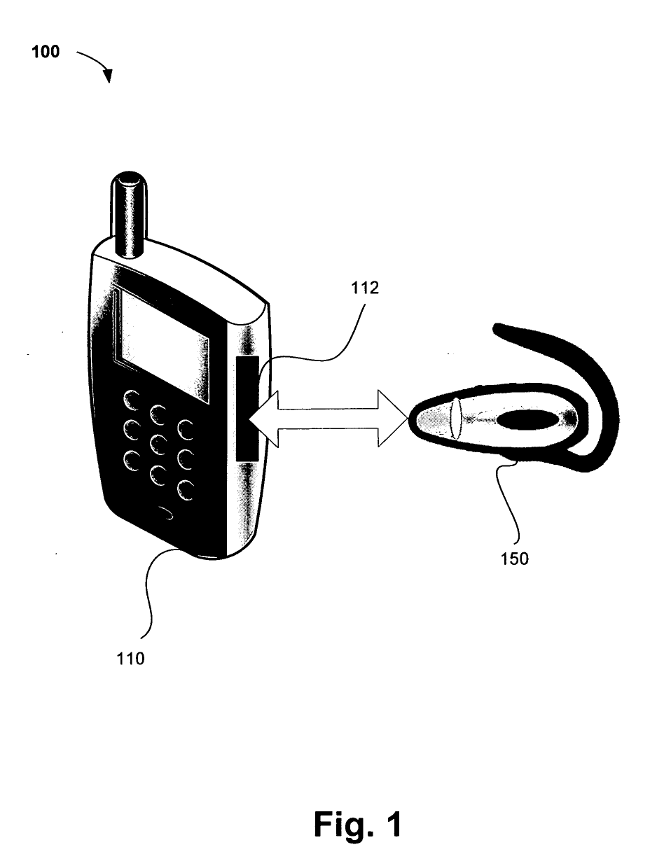

Turning to FIG. 1, a wireless communication system 100 according to various inventive embodiments may include any type of primary computing or communication device 110 such as a cell phone; personal digital assistant, gaming device, laptop, ultra mobile personal computer, or even a desktop personal computer having a wireless network adaptor. Primary communication device 110 may be capable of wirelessly communicating over tens, hundreds and perhaps thousands of meters (i.e., long-range communications) with a network access station such as a base station or access point. Primary communication device 110 may also be capable of wirelessly communicating with a secondary short range communication device 150 using short-range frequencies and/or protocols.

For example, primary communication device 110 may be configured to use one or more protocols specified in by the Institute of Electrical and Electronics Engineers (IEEE) 802.11a, b, g or n standards for wireless local area networks (WLANS) such as IEEE 802.11a-1999; IEEE 802.11b-1999/Cor1-2001; IEEE 802.11g-2003; and/or IEEE 802.11n (not yet published) or for wireless metropolitan area networks (WMANs) such as IEEE 802.16 standards for broadband wireless access such as IEEE 802.16-2004/Cor1-2005 or IEEE 802.16-2005 Amendment although the inventive embodiments are not limited in this respect.

Alternatively or in addition, primary communication device 110 may use protocols for wireless wide area networks (WWANs) or cellular networks such a those compatible with the 3rd Generation Partnership Project (3GPP), code division multiple access (CDMA) networks, or any other single carrier or multi-carrier network protocols.

Both primary communication device 110 and short range communication device 150 may be configured to communicate with each other using short range wireless communication protocols such as BLUETOOTH™, or protocols for WPANs compatible with IEEE 802.15 standards such as ultra wide band (UWB) and/or millimeter Wave (mmW) protocols.

In certain embodiments, short range device 150 may be a wireless headset for conveying voice and/or video information of a user to and from a network access station via communication device 110. As mentioned previously, communication devices and wireless headsets are separately well known in the art and thus more detailed description of their conventional operation is therefore omitted. However, according to inventive embodiments herein, primary communication device 110 may be adapted to reduce the independent nature of short range device 150 by incorporating a charging and/or storing port 112.

For example, in one embodiment, primary communication device 112 may include a port 112 which is adapted to store the short range wireless device 150 when it is not in use. In this manner, a user may carry or store both primary device 110 and short range device 150 as a single unit.

In other embodiments, instead of serving as a storage area, port 112 may serve as an electrical charging port to charge a battery in short range device 150 via the power resources of primary communication device 110. In yet further embodiments, port 112 may serve as both a storage area and a charging port for short range communication device 150. Thus by way of example, a user may carry a cellular device that will include an integrated BLUETOOTH™ headset. While carried in an integrated mode, the headset may be charged from the cellular device battery. Advantages obtained by the inventive embodiments over the separate systems of the conventional art include enhanced user mobility, minimized number of carry-on items for air travel, no need for separate charging of the wireless headset and manual synchronization between the headset and mobile device may no longer be required.

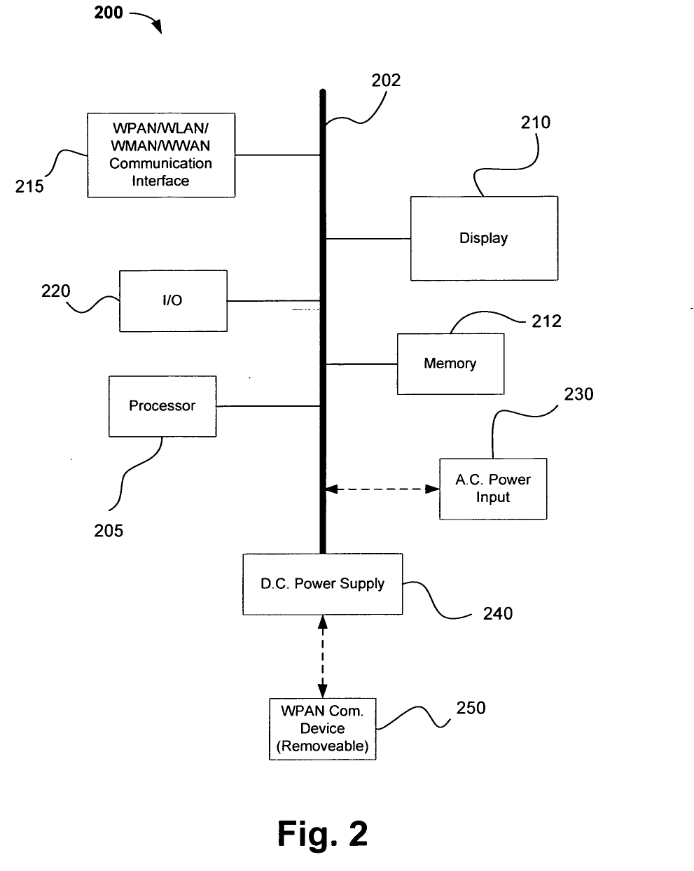

Turning to FIG. 2, a general block diagram is shown for an example communication system 200 having a power distribution for various embodiments of system 100 of FIG. 1. It should be recognized that system 200 of FIG. 2 is shown for purposes of understanding functional principles of the inventive embodiments and is not intended to show actual circuit-level or component-level architecture. System 200 may include a power bus 202 to supply power to various components of a communication platform such as a processor 205, a display device 210, memory 212, communication interface 215, and/or various input output devices (I/O) 220.

Bus 202 may be implemented as substrate power lines and/or connectors or part of a component communication or power bus. Bus 202 may be coupled to a direct current D.C. power supply 240 such as a lithium Ion (Li-Ion) or other type of battery and/or an alternating current (AC) power supply 230 which may include an A.C. to D.C. transformer, to provide power to various components of system 200.

According to certain embodiments of the present invention, D.C. power supply 240 of system 200 may also be used to provide power to a short range communication device 250 such as a BLUETOOTH™ enabled wireless headset or other removable WPAN communication device as discussed previously. Thus when WPAN device 250 is connected to system 200, D.C. power supply 240 of system 200 thus provides the power for charging the battery of WPAN device 250.

Communication interface 215 may be a network adaptor for a computer or may include various components to provide the OTA interfaces for WPAN communication with WPAN device 250 and one or more of the WLAN, WMAN or WWAN protocols for longer range communications as discussed above. I/O 220 may include various on-board equipment such as a keyboard, cursor controller, microphone, speaker as well as any external ports such as a headset jack, universal serial bus (USB), infrared (IR) or other type of serial or parallel communication port. Memory 212 may be any type of volatile or non-volatile memory to store information to be used by processor 205. In certain embodiments, memory 212 may include a fixed or removable flash memory.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. An apparatus for wireless communication, the apparatus comprising:
a portable communication device configured to communicate using a wireless personal area network (WPAN) protocol and one or more wireless local area network (WLAN), wireless metropolitan area network (WMAN) or wireless wide area network (WWAN) protocols, wherein the portable communication device includes a port to charge a battery of a separate WPAN device.

2. The apparatus of claim 1 wherein the portable communication device comprises a mobile phone and wherein the separate WPAN device comprises a wireless headset.

3. The apparatus of claim 2 wherein the apparatus comprises both the portable communication device and the wireless headset.

4. The apparatus of claim 1 wherein the WPAN protocols comprise BLUETOOTH™ protocols.

5. The apparatus of claim 1 wherein the portable communication device includes a cavity to store the WPAN device at least partially within the portable communication device when the WPAN device is coupled to the port.

6. The apparatus of claim 1 wherein the portable communication device comprises a portable computer using WLAN protocols compatible with one or more of the Institute of Electrical and Electronic Engineers (IEEE) 802.11 standards.

7. The apparatus of claim 1 wherein the apparatus uses WMAN protocols compatible with the IEEE 802.16-2005 standard.

8. An apparatus for wireless communication comprising:
a processor;
a radio frequency (RF) communication interface in communication with the processor, the RF communication interface adapted to communicate wirelessly with both wireless personal area network (WPAN) devices and one or more wireless local area network (WLAN), wireless metropolitan area network (WMAN) or wireless wide area network (WWAN) devices;
a power supply to power the processor and RF communication interface; and
a charging port coupled to the power supply and configured to charge a separate wireless headset unit from the power supply.

9. The apparatus of claim 8 wherein the charging port is configured to store the separate wireless headset unit at least partially within the apparatus when the wireless headset unit is coupled to the charging port.

10. The apparatus of claim 8 wherein the RF communication interface uses BLUETOOTH™ protocols to communicate with the separate wireless headset.

11. The apparatus of claim 8 wherein the RF communication interface uses ultra wideband (UWB) protocols to communicate with the separate wireless headset.

12. The apparatus of claim 8 wherein the apparatus comprises one of a mobile phone, a personal computer, or a personal digital assistant.

13. The apparatus of claim 8 wherein the power source comprises a battery.

14. The apparatus of claim 8 wherein RF communication interface uses protocols compatible with one or more of the Institute of Electrical and Electronic Engineers (IEEE) 802.11 or 802.16 standards to respectively communicate with WLAN or WMAN devices.

15. The apparatus of claim 8 wherein the RF communication interface uses global system for mobile communications (GSM) or code division multiple access (CDMA) protocols for communication with WWAN devices.

16. A mobile communication system comprising:
a portable communication device comprising a processor, a flash memory coupled with the processor and a wireless headset storage port; and
a wireless headset adapted to wirelessly communicate with the portable communication device using wireless personal area network (WPAN) protocols, wherein the wireless headset storage port of the portable communication device is configured to receive and store the wireless headset when the wireless headset is not in use.

17. The system of claim 16 wherein the WPAN protocols comprise BLUETOOTH™ protocols.

18. The system of claim 16 wherein the wireless headset storage port is further configured as a charging port to charge a battery in the wireless headset from a battery in the portable communication device.

19. The system of claim 16 wherein the portable communication device comprises a mobile phone.

20. The system of claim 16 wherein the portable communication device comprises one of a lap top computer or ultra mobile personal computer.
